(19) United States
(12) Patent Application Publication
(10) Pub. No.: US 2025/0321598 A1
(43) Pub. Date: Oct. 16, 2025

(54) UNMANNED AERIAL VEHICLE, AND CONTROL SYSTEM AND CONTROL METHOD OF UNMANNED AERIAL VEHICLE

(71) Applicants: Kubota Corporation, Osaka (JP); ISHIKAWA ENERGY RESEARCH CO.,LTD., Ota-shi (JP)

(72) Inventors: Kohei SEINO, Sakai-shi (JP); Hiroyuki NAGASHIMA, Ota-shi (JP); Hiroshi KITAGAWA, Ota-shi (JP); Hidetaka KAYANUMA, Ota-shi (JP)

(21) Appl. No.: 19/247,989

(22) Filed: Jun. 24, 2025

Related U.S. Application Data
(63) Continuation of application No. PCT/JP2022/048182, filed on Dec. 27, 2022.

(51) Int. Cl. G05D 1/85; G05D 1/654; G05D 1/86; G05D 109/25

(52) U.S. Cl. CPC G05D 1/854; G05D 1/6546; G05D 1/86; G05D 2109/254

(57) ABSTRACT

An unmanned aerial vehicle includes a plurality of rotors, a plurality of electric motors each configured to drive a respective one of the plurality of rotors, a power source, and a controller configured or programmed to control supply of first electric power from the power source to the plurality of electric motors and supply of second electric power from the power source to an external implement, and control operation of the plurality of electric motors. Upon detecting an abnormality in equipment included in the unmanned aerial vehicle, the controller is configured or programmed to stop the supply of the second electric power to the implement and maintain the supply of the first electric power to the plurality of electric motors to execute flight using the plurality of rotors.

### CROSS REFERENCE TO RELATED APPLICATIONS

This application is a Continuation Application of PCT Application No. PCT/JP2022/048182 filed on Dec. 27, 2022. The entire contents of this application are hereby incorporated herein by reference.

### BACKGROUND OF THE INVENTION

### 1. Field of the Invention

The present disclosure relates to unmanned aerial vehicles, and control systems and control methods for unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2022-104737 describes an unmanned aerial vehicle (unmanned flying body) that changes its flight position in coordination with the operation of an agricultural machine.

### SUMMARY OF THE INVENTION

Example embodiment of the present disclosure provides systems capable of performing various ground operations by supplying power from an unmanned aerial vehicle to an implement connected to the unmanned aerial vehicle. Additional example embodiments of the present disclosure provide systems and methods for appropriately controlling an operation of an unmanned aerial vehicle when an abnormality occurs in equipment of the unmanned aerial vehicle while flying with an implement being powered.

In a non-limiting example embodiment of the present disclosure, an unmanned aerial vehicle includes a plurality of rotors, a plurality of electric motors each configured to drive a respective one of the plurality of rotors, a power source, and a controller configured or programmed to control supply of first electric power from the power source to the plurality of electric motors and supply of second electric power from the power source to an external implement, and control operation of the plurality of electric motors. Upon detecting an abnormality in equipment included in the unmanned aerial vehicle, the controller is configured or programmed to stop the supply of the second electric power to the implement and maintain the supply of the first electric power to the plurality of electric motors to execute flight using the plurality of rotors.

In a non-limiting example embodiment of the present disclosure, a control system for an unmanned aerial vehicle including a plurality of rotors, a plurality of electric motors each configured to drive a respective one of the plurality of rotors, a power source, and a coupler that couples an implement performing ground operations. The control system includes a controller configured or programmed to control supply of first electric power from the power source to the plurality of electric motors and supply of second electric power from the power source to the implement, and control operation of the plurality of electric motors. When the controller detects an abnormality in equipment included in the unmanned aerial vehicle, the controller is configured or programmed to stop the supply of the second electric power to the implement and maintain the supply of the first electric power to the plurality of electric motors to execute flight using the plurality of rotors.

In a non-limiting example embodiment of the present disclosure, a control method for controlling an unmanned aerial vehicle including a plurality of rotors, a plurality of electric motors each configured to drive a respective one of the plurality of rotors, a power source, and a coupler that couples an implement performing ground operations. The control method includes controlling supply of first electric power from the power source to the plurality of electric motors and supply of second electric power from the power source to the implement, controlling operation of the plurality of electric motors, detecting an abnormality in equipment included in the unmanned aerial vehicle, and when the abnormality is detected, stopping the supply of the second electric power to the implement and maintaining the supply of the first electric power to the plurality of electric motors to execute flight using the plurality of rotors.

According to example embodiments of unmanned aerial vehicles, and control systems and control methods of the present disclosure, when an equipment abnormality occurs in an unmanned aerial vehicle that is flying while supplying power to an implement, it is possible to appropriately control the operation of the unmanned aerial vehicle.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3A is a top view schematically showing a multicopter according to an example embodiment of the present disclosure.

FIG. 3B is a side view schematically showing the multicopter.

FIG. 4 is a block diagram showing an example of system configuration in the multicopter.

FIG. 5 is a flowchart showing the operation of the multicopter.

FIG. 6A is a plan view showing one example of a flight path of the multicopter.

FIG. 6B is a plan view showing another example of a flight path of the multicopter.

FIG. 7A is a first figure showing an example of operation when an abnormality occurs in the main rotor drive system during operation.

FIG. 7B is a second figure showing an example of operation when an abnormality occurs in the main rotor drive system during operation.

FIG. 7C is a third figure showing an example of operation when an abnormality occurs in the main rotor drive system during operation.

FIG. 8 is a block diagram showing an example of system configuration in a battery-powered multicopter.

FIG. 9 is a block diagram showing an example of hardware configuration of the controller.

FIG. 10 is a diagram schematically showing an example of a communication network to which the multicopter is connected.

### DETAILED DESCRIPTION OF THE EXAMPLE EMBODIMENTS

Unmanned aerial vehicles each includes a plurality of rotors and a rotation driver to rotate the rotors (hereinafter referred to as “propellers”). Hereinafter, such an unmanned aerial vehicle is referred to as a “multicopter”.

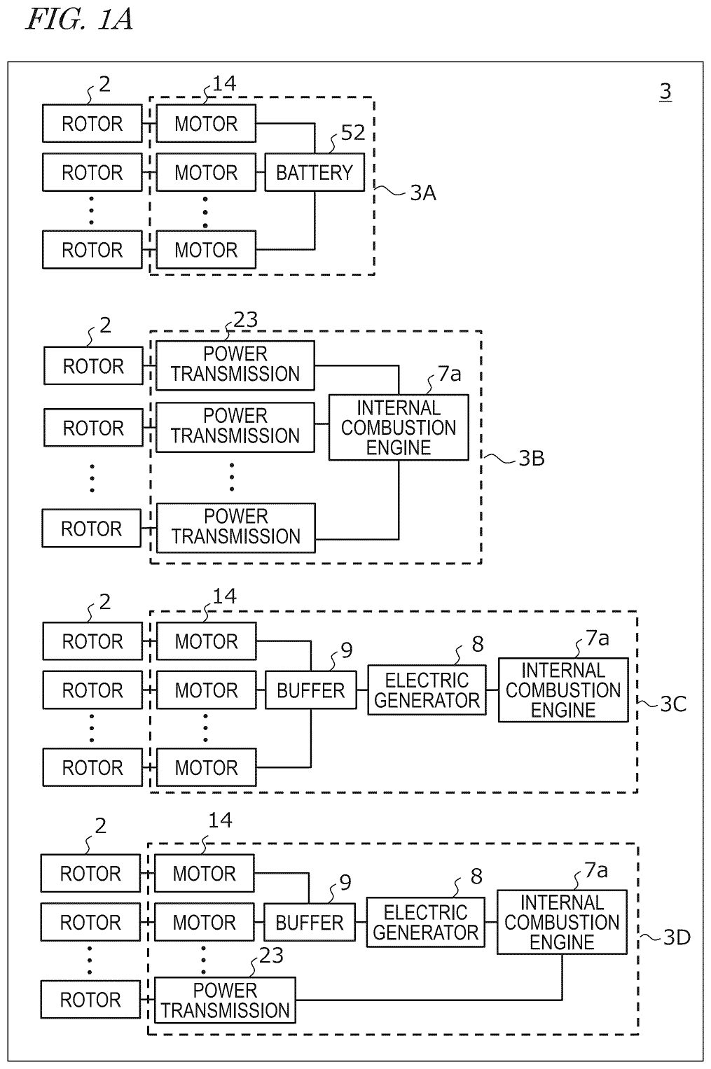

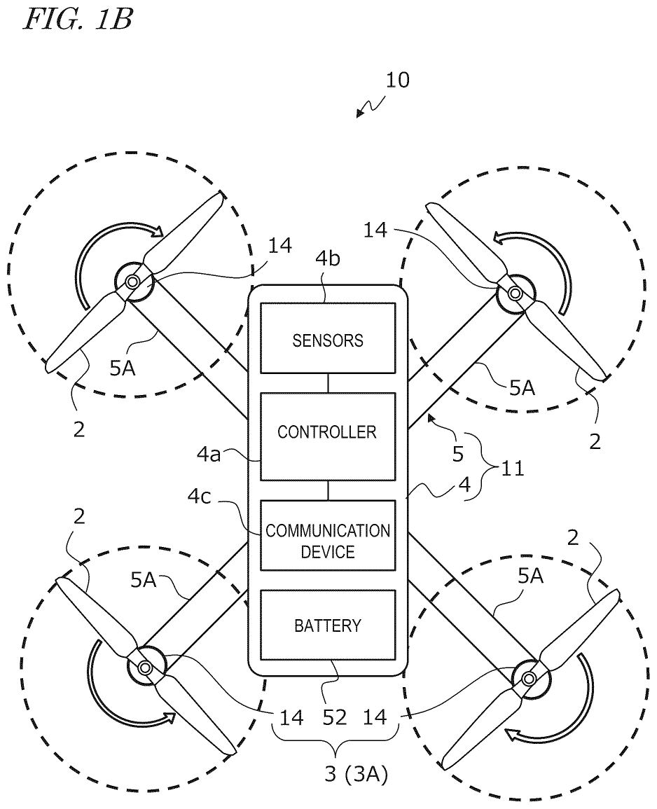

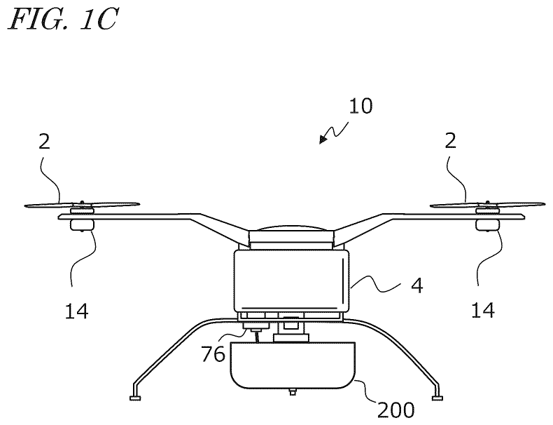

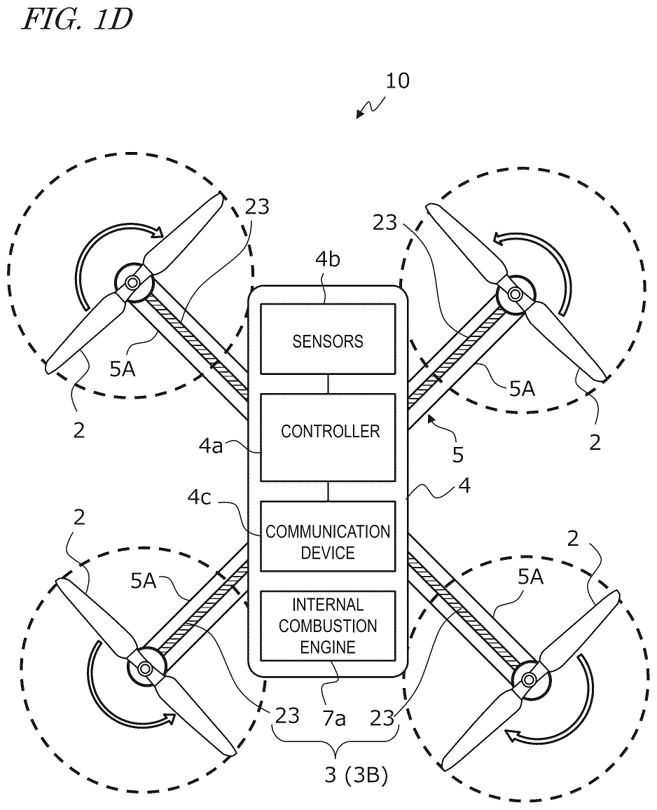

The configuration of rotation drivers included in multicopters exists in various forms. FIG. 1A is a schematic block diagram showing four examples of rotation driver 3 in the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called a “series hybrid driver”. The electric generator 8 and internal combustion engine 7a in series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of driver is called a “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) including four rotors 2. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imaging device, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used for measuring distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute some or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned further inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23. Rotation driver 3B may include a mechanism for changing the pitch angle of blades of each of the plurality of rotors 2. In that case, the controller 4a may adjust the lift generated by each rotor 2 by controlling that mechanism to change the blade pitch angles.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used to both generate thrust and attitude control. The main rotors may be called a “booster rotors” and the sub-rotors may be called a “attitude control rotors”.

In the parallel hybrid driver, the internal combustion engine is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt a parallel hybrid driver or a series hybrid driver to increase payload and flight duration. Note that when the rotation driver 3 includes a mechanism for changing the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes power supply 76. The power supply 76 supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery for storing power.

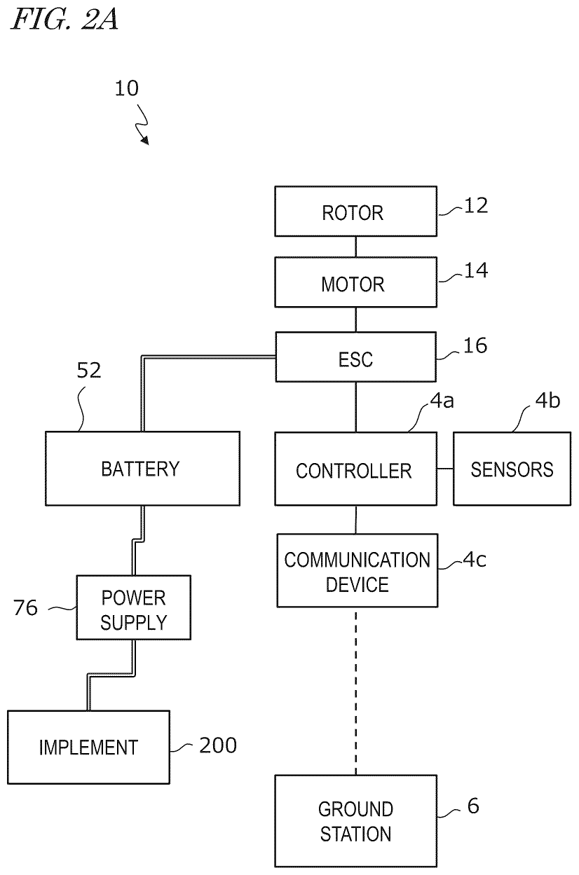

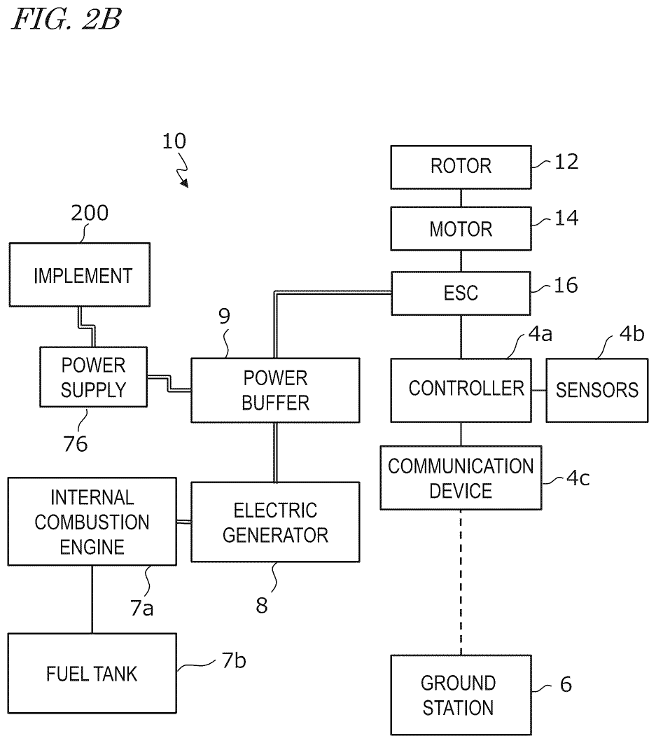

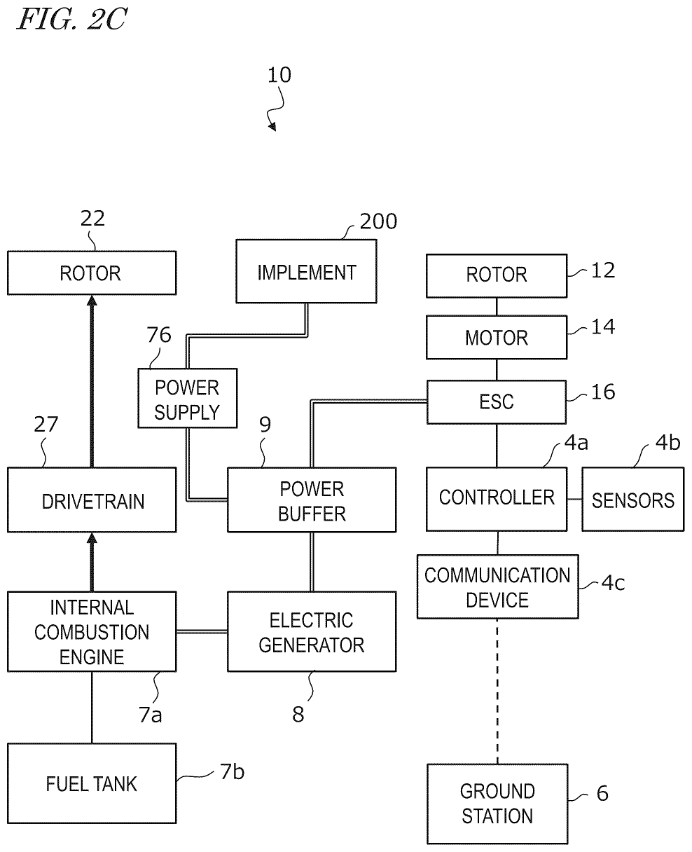

FIG. 2A shows a block diagram of a basic configuration example of a battery-driven multicopter 10. The battery-driven multicopter 10 includes a plurality of rotors 12, a plurality of motors 14, each configured to drive a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a for controlling a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may be configured or programmed to receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's controller on the ground. The controller 4a may be configured or programmed to perform functions to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless means.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each configured to drive a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits driving force from the internal combustion engine 7a, and the rotor 22 that rotates upon the receiving driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

The following describes configuration examples and operation examples of an unmanned aircraft according to example embodiments of the present disclosure, taking a parallel hybrid drive multicopter as an example.

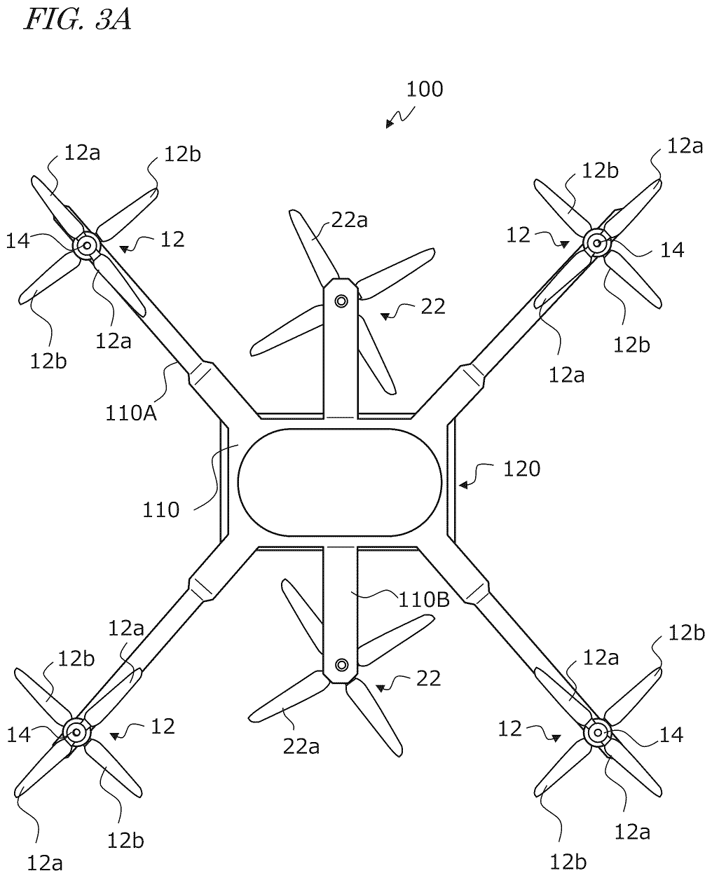

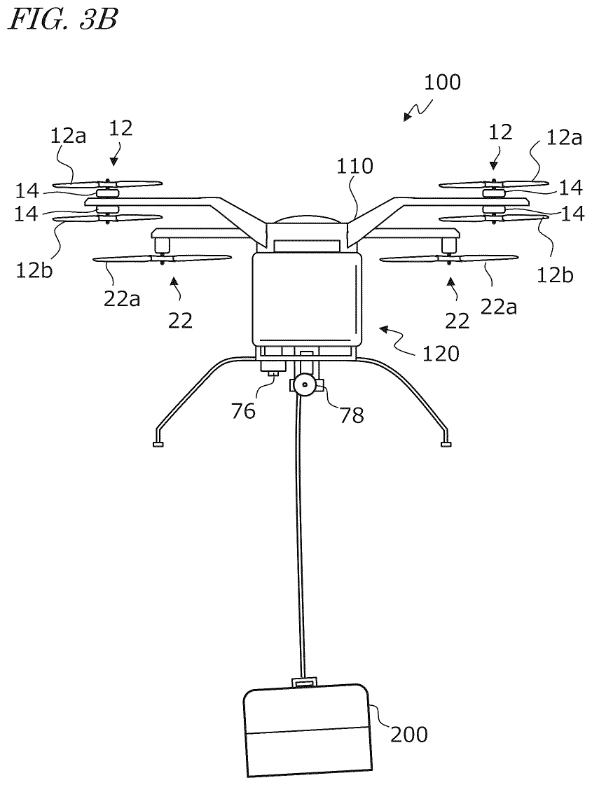

FIG. 3A is a top view schematically showing a multicopter 100 according to the present example embodiment, and FIG. 3B is a side view thereof. In FIG. 3B, an implement 200 connected to the multicopter 100 is shown. The multicopter 100 may be connected with cargo, agricultural materials, other machinery, or containers, cases, or packages capable of accommodating them, together with or in place of the implement 200. Hereinafter, the weight of the implement 200 and the implement itself may be referred to as “payload”. FIG. 3B shows that multicopter 100 includes a coupler for suspending the implement 200. The “coupling” between the multicopter 100 and the implement 200 or the like may be made by various devices or apparatuses.

The multicopter 100 shown in FIG. 3A includes eight sub-rotors 12 and two main rotors 22, for example. The sub-rotors 12 include four sets of propellers 12a and 12b that rotate in opposite directions on the same axis. Each of propellers 12a and 12b includes two blades, for example. The propellers 12a, 12b are each rotated by motors 14. The four sets of propellers 12a and 12b rotating in opposite directions on the same axis are located at vertices of a quadrilateral. The main rotors 22 include two propellers 22a rotating in opposite directions at different positions. Each propeller 22a includes four blades. The eight propellers 12a, 12b of sub-rotor 12 have the same pitch angle and diameter. The two propellers 22a of main rotor 22 also have the same pitch angle and diameter. The diameter of propeller 22a is about 1.2 times or more, for example, about 1.4 times or more and about 2.0 times or less, than the diameter of propellers 12a and 12b.

The multicopter 100 includes a body frame 110 including four arms 110A for the sub-rotors 12 and two arms 110B for the main rotors 22, for example. The body frame 110 supports a main body 120 including various electronic components and mechanical components described later.

In the example of FIG. 3B, the main body 120 includes a power supply 76 and an actuator 78 used as a coupler to connect to the implement 200 and other purposes. The power supply 76 is a device that supplies power generated within the main body 120 to the implement 200. The actuator 78 is a device such as an electric motor that performs operations for connecting the implement 200 to the main body 120 of the multicopter 100. In the example of FIG. 3B, the actuator 78 drives a mechanism for winding up a cable connecting the main body 120 and the implement 200. This cable may include a power line for supplying power to the implement 200 from the multicopter 100, and a communication line for communication between the multicopter 100 and the implement 200.

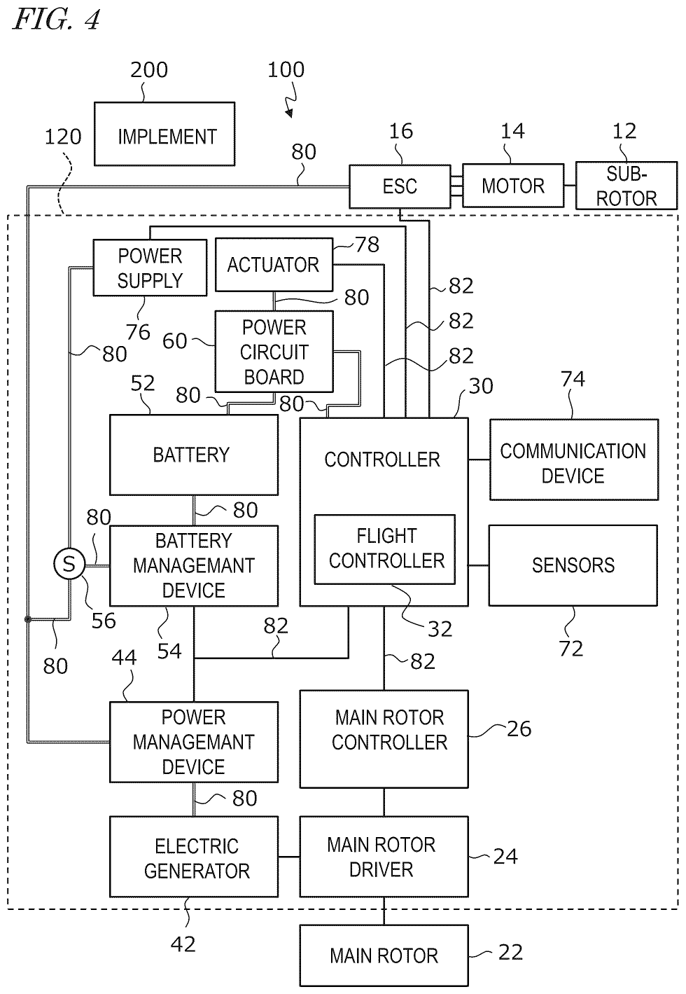

FIG. 4 is a block diagram showing an example of the system configuration of the multicopter 100 according to the present example embodiment.

In the illustrated example, the main body 120 of the multicopter 100 includes a controller 30 configured or programmed to include a flight controller 32, sensors 72, and a communication device 74. These are basically similar to the controller 4a, sensors 4b, and communication device 4c included in the main body 4 of the multicopter 10 explained with reference to FIG. 1A.

The multicopter 100 according to the present example embodiment includes eight sub-rotors 12, eight motors 14 that respectively rotate the eight sub-rotors 12, and eight ESCs that respectively control the eight motors 14, for example. Each ESC 16 receives a motor control signal for controlling the motor 14 from the controller 30 via wiring 82. The motor control signal is, for example, a PWM (Pulse Width Modulation) signal. When the motor control signal is a PWM signal, the duty cycle of the PWM signal may indicate an analog value of the motor rotation speed. Each ESC 16 controls the rotation speed of the motor 14 connected to that ESC 16 based on the motor control signal from the controller 30. In FIG. 4, for simplicity, one set of “sub-rotor 12, motor 14 and ESC 16” is shown, but the multicopter 100 according to the present example embodiment includes eight sets of “sub-rotor 12, motor 14 and ESC 16”, for example. The number of these sets is not limited to eight.

The controller 30 is connected to individual ESCs 16 via electrically independent wiring 82 and may individually control each of the eight ESCs 16. As mentioned earlier, the sub-rotor 12 is used not only for generating lift but also for attitude control. Attitude control is achieved by the flight controller 32 of the controller 30 obtaining measured or estimated values indicating the attitude of the main body 120 from the sensors 72 to determine the current attitude of the main body 120, and controlling the rotation speed of individual motors 14 according to the difference from the target attitude.

The main body 120 includes a main rotor driver 24 that drives the main rotor 22 and a main rotor controller 26 that controls the main rotor driver 24. In this example embodiment, the main rotor driver 24 is an internal combustion engine. Therefore, the main rotor controller 26 includes an Engine Controller (ECU). The main rotor controller 26 is configured or programmed to execute control of the internal combustion engine by acquiring sensor data such as throttle opening, intake temperature, engine speed, and temperature of various portions of the main rotor driver 24, which is an internal combustion engine. The main rotor controller 26 is connected to the controller 30 via wiring 82 such as a CAN (Controller Area Network) bus. The main rotor controller 26 is configured or programmed to output engine control signals based on signals transmitted from the controller 30. The engine control signal includes, for example, throttle opening. A digital-to-analog converter (DAC) and/or voltage converter may be connected between the controller 30 and the main rotor controller 26. Mechanical devices such as a clutch and reduction gear may be provided between the main rotor driver 24 and the main rotor 22.

The main rotor driver 24 preferably is an internal combustion engine with minimal vibration. In this example embodiment, the main rotor driver 24 is, for example, an opposed piston engine. The opposed piston engine is disclosed in, for example, Japanese Patent No. 5508604. The entire contents of Japanese Patent No. 5508604 are hereby incorporated by reference.

The main rotor driver 24, which is an internal combustion engine, may drive an electric generator 42 such as an alternator to generate power. In this example embodiment, the electric generator 42 has the structure of an AC synchronous motor including a rotor and a stator. Therefore, the electric generator 42 may also function as a “starter” by rotating the rotor through energization during startup of the main rotor driver 24. The electric generator 42 rectifies the alternating current generated by power generation to convert it to direct current. The electric generator 42 generates direct current power required for driving the motor 14 and supplies it to each ESC 16 via wiring 80. The electric generator 42 is configured to output, for example, a direct current voltage of 250V or higher. Note that the wiring 80 is power wiring, and the wiring 82 is signal wiring. Each of wirings 80 and 82 includes a plurality of conductors.

The electric generator 42 is connected to a power management controller 44. The power management controller 44 is connected to the controller 30 and a battery management controller 54 to be described later. The power management controller 44 may be configured or programmed to control the amount of power generation by the electric generator 42 based on signals from the controller 30 or the battery management controller 54. This amount of power generation may be variably controlled by the power management controller 44 according to the power required by the motor 14 and battery 52, even when the engine speed of the main rotor driver 24, which is an internal combustion engine, is in a constant state.

The main body 120 further includes a battery 52 including a plurality of cells of, for example, lithium-ion secondary batteries connected in series or parallel, and a battery management controller 54 that controls charging and discharging of the battery 52.

The battery 52 may receive direct current power from the electric generator 42 via a power switch 56 and be charged by that power. The operation of the power switch 56 may be controlled by the battery management controller 54 and the controller 30. The battery management controller 54 is configured or programmed to measure or estimate parameter values defining the state of battery 52, such as current flowing through battery 52, cell voltage, cell balance, State Of Charge (SOC), State Of Health (SOH), and temperature.

The battery management controller 54 may be configured or programmed to control the power switch 56 according to the state of the battery 52. For example, when the battery 52 is in a state requiring charging, the battery management controller 54 electrically connects the electric generator 42 and battery 52 by means of the power switch 56, and supplies power from the electric generator 42 to the battery 52 to execute charging operation. At this time, the battery management controller 54 may be configured or programmed to control the power management controller 44 and increase the amount of power generation by the electric generator 42 so that the power supplied to ESC 16 does not fall below a desired level. In contrast, when the battery 52 is in a state not requiring charging, the battery management controller 54 disconnects the electrical connection between the electric generator 42 and battery 52 by the power switch 56, thereby stopping the charging of the battery 52.

In this example embodiment, the battery 52 has a power storage capacity that allows, even when power generation by the electric generator 42 stops for some reason and lift from the main rotor 22 is lost, continued generation of lift and attitude control by the sub-rotor 12 to fly to a location where landing is possible and land there. In other words, when the multicopter 100 according to this example embodiment is flying normally, the power required to drive the sub-rotor 12 can be supplied to ESC 16 from the electric generator 42 rather than from the battery 52. Therefore, even when increasing payload and flight duration, there is little need to increase the power storage capacity of battery 52 accordingly.

The power stored in battery 52 may be output as, for example, a direct current voltage of 250V or higher. However, this direct current voltage decreases with decreasing state of charge. Therefore, when the state of charge falls below a predetermined level, the battery management controller 54 operates to supply a portion of the direct current power from the electric generator 42 to battery 52 to charge battery 52.

The battery 52 is connected to a power circuit board 60. The power circuit board 60 has the function of stepping down the voltage output from battery 52 to, for example, 24V, 12V, and 5V. The direct current voltage output from battery 52 is converted to a desired voltage by the power circuit board 60 before being supplied to other electronic components. In the example of FIG. 4, power stepped down by the power circuit board 60 is supplied to the controller 30 and actuator 78 via wiring 80.

In the example of FIG. 4, the power supply 76 is electrically connected to the electric generator 42 or battery 52 via the power switch 56. The power supply 76 in this example is configured to supply power generated within the main body 120 to external machines or devices such as the implement 200.

The main body 120 may have configurations not shown in FIG. 4. For example, the main body 120 may include a fuel tank for storing fuel required for operation of the main rotor driver 24, water-cooled or air-cooled devices for cooling the main rotor driver 24, and electrical equipment such as lighting devices and electric pumps. The electrical equipment may operate on power stepped down to a predetermined voltage by the power circuit board 60. Additionally, a battery (auxiliary battery) for electrical equipment may be provided and configured to supply power to the electrical equipment. Such an auxiliary battery may be charged from the battery 52 or the electric generator 42.

In this example embodiment, the motor 14 functions as a plurality of “attitude controllers” that respectively drive a plurality of first rotors (sub-rotors) 12. Additionally, the main rotor driver 24, which is an internal combustion engine, functions as a “main thrust generating device” that drives the second rotor (main rotor) 22.

In this example embodiment, the controller 30 can vary the ratio (thrust ratio) between the total thrust from the sub-rotors 12 obtained from the plurality of motors 14 (first thrust) and the total thrust from the main rotors 22 obtained from the main rotor driver 24 (second thrust).

Generally, the responsiveness of motor 14 is superior to that of internal combustion engines. Regarding the torque required for rotation of rotors 12 and 22, when the time from the input of a torque command signal to the achievement of the torque target value is called the “response time”, the response time of motors is, for example, about 1/100 of that of internal combustion engines. Therefore, to control the attitude of the multicopter 100, it is desirable to detect the difference between the current value and target value of the attitude angle of the multicopter 100, and control the rotation speed of each of the plurality of sub-rotors 12 with high response speed to reduce this difference. An increase in rotor rotation speed generates an increase in thrust. By adjusting the thrust of each of the plurality of sub-rotors 12, it is possible to control the attitude of the multicopter 100 with high precision and quickly.

In contrast, internal combustion engines efficiently generate large thrust. While the rotation of sub-rotor 12 is performed using power generated by the power of the main rotor driver 24, which is an internal combustion engine, energy loss occurs when converting mechanical energy to electrical energy. Therefore, from the viewpoint of improving energy consumption efficiency, it is preferable that the main rotor driver 24 be used for main thrust generation by rotating the main rotor 22. Additionally, to increase the thrust of main rotor 22, it is preferable that the diameter of each main rotor 22 be larger than the diameter of each of the plurality of sub-rotors 12.

In the example shown in FIG. 4, the electric generator 42 and battery 52 function as power sources of the multicopter 100. From these power sources, power (first power) is supplied to the plurality of motors 14, power (second power) is supplied to the external implement 200, and power (third power) for charging is supplied from the electric generator 42 to the battery 52. The controller 30 is configured or programmed to control the supply of first power from the power source to the plurality of electric motors 14, and the supply of second power from the power source to the implement 200 via the power supply 76. In the example of FIG. 4, the controller 30 can control the supply of power from the electric generator 42 or battery 52 to the implement 200 by controlling the power switch 56. Additionally, the controller 30 can control the supply of power from the battery 52 to the plurality of motors 14 by controlling the power switch 56. Furthermore, the controller 30 can control the supply of power from the electric generator 42 to the plurality of motors 14 by controlling the power management controller 44.

In this example embodiment, the sensors 72 include at least one sensor that measures the throttle opening, intake temperature, engine speed, and/or temperature of various components of the main rotor driver 24, which is an internal combustion engine, and outputs sensor data indicating these measurements. This sensor data is used not only to control the internal combustion engine but may also be used to detect abnormalities in the internal combustion engine. The sensors 72 may also include sensors to detect abnormalities in other devices, such as the electric generator 42, main rotor 22, power transmission system to the main rotor 22, and/or fuel supply system to the internal combustion engine. More specifically, the sensors 72 may include sensors that detect, for example, output voltage or output current of the electric generator 42, rotation speed of the rotor of the electric generator 42, rotation speed of the main rotor 22, rotation speed of gears included in the power transmission system of the main rotor 22, remaining amount of fuel in the fuel tank, temperature of the fuel tank, temperature of cooling water of the internal combustion engine, or rotation speed or torque of the output shaft of the internal combustion engine. The controller 260 may be configured or programmed to monitor the state of at least one of the internal combustion engine, electric generator, main rotor 22, power transmission system to the main rotor 22, and fuel supply system to the internal combustion engine based on the output from one or more such sensors.

The controller 30 can detect abnormalities in equipment included in the multicopter 100 based on sensor data output from at least one sensor included in the sensors 72. For example, the controller 260 can detect abnormalities in the state of at least one of the internal combustion engine, electric generator, main rotor 22, power transmission system to the main rotor 22, and fuel supply system to the internal combustion engine. When the controller 30 detects an abnormality in the equipment, it stops the supply of power to the implement 200 and maintains the supply of power to the plurality of electric motors 14 to execute flight using the plurality of sub-rotors 12. For example, when the controller 30 detects an abnormality in the equipment while flying the multicopter 100 while supplying power to the implement 200 via the power supply 76, it operates in an emergency flight mode where it stops power supply to the implement 200 and flies the multicopter 100. More specifically, when the controller 30 detects an abnormality in the equipment while executing flight by controlling the plurality of motors 14 and the main rotor driver 24 (internal combustion engine) while supplying power to the implement 200, it controls the power switch 56 to stop the supply of power from the electric generator 42 and battery 52 to the implement 200. At this time, the controller 30 maintains the supply of power from the battery 52 to the plurality of electric motors 14 to continue flight using the plurality of sub-rotors 12. When the equipment abnormality is an abnormality in the main rotor 22 drive system, the controller 30 stops the operation of the main rotor 22 via the main rotor controller 26 and continues flight by driving only the sub-rotors 12. Here, the drive system of the main rotor 22 includes the main rotor 22, power transmission system to the main rotor 22, internal combustion engine, electric generator 42, and fuel supply system to the internal combustion engine. When the multicopter 100 is flying by driving only the sub-rotors 12, the rotation speed of each sub-rotor 12 may be increased to compensate for the decrease in thrust due to the stopping of the main rotor 22. After stopping the power supply to the implement 200 and the operation of the main rotor 22, the controller 30 may fly the multicopter 100 to a position above a possible landing point by driving only the sub-rotors, and land the multicopter 100 at that point by decreasing the rotation speed of each sub-rotor 12.

With such operation, when an equipment abnormality (e.g., failure) occurs during flight involving ground operations by the implement 200, it is possible to suppress the loss of energy from the battery 52 due to power supply to the implement 200, and to secure sufficient time for flight in emergency flight mode. This makes it possible, even when the main rotor 22 cannot be driven due to a malfunction in the drive system of the main rotor 22, to continue flight by driving only the sub-rotors 12 and to fly the multicopter 100 to a point where landing is possible.

Note that when the controller 30 detects an equipment abnormality, instead of stopping power supply to the implement 200, it may reduce the amount of power supplied to the implement 200. The controller 30 may adjust the amount of power supply to the implement 200 based on the amount of power required until landing and the remaining amount of energy stored in the battery 52 (power source). For example, the controller 30 may restrict the power supply to the implement 200 to be smaller as the value obtained by subtracting the estimated power amount required until landing from the energy remaining amount of the battery 52 at the time abnormality is detected becomes smaller. With such control, it is possible to drive the implement 200 within possible limits even when an abnormality occurs.

Thus, in this example embodiment, even when power supply from the electric generator 42 to the plurality of motors 14 is stopped due to an abnormality in equipment such as the internal combustion engine or electric generator 42, it is possible to stop or limit power supply to the implement 200 and maintain power supply from the battery 52 to the plurality of motors 14. This allows the multicopter 100 to continue flying for a while by driving only the plurality of sub-rotors 12. By incorporating such a function based on a failsafe concept, it is possible to continue the flight of the multicopter 100 even when an equipment abnormality occurs, and to land the multicopter 100 at a possible landing point.

To implement such functions, in this example embodiment, the battery management controller 54 controls charging to always maintain the state of charge (SOC) of the battery 52 at or above a certain level when there is no abnormality in the equipment. For example, while flying using the plurality of sub-rotors 12 and the main rotor 22 with the implement 200 being driven, the battery management controller 54 may maintain the state of charge of the battery 52 at a value higher than a threshold (for example, 80%) required for the operation of continuing flight by the plurality of sub-rotors 12 and then landing when an equipment abnormality is detected. The threshold may be set within a range of, for example, 70% to 90%. This threshold may be set to an appropriate value according to the total weight of the multicopter 100 and the implement 200. For example, the controller 30 may obtain information about the weight of the implement 200 suspended by the coupler of the multicopter 100, and change the threshold according to that weight. When the weight of the implement 200 is known and the information about that weight is recorded in advance in a storage device, the controller 30 can obtain the information about the weight of the implement 200 from that storage device. Alternatively, the sensors 72 may include a sensor that measures the weight of the implement 200 suspended from the multicopter 100. In that case, the controller 30 can obtain information about the weight of the implement 200 from the measurement value of that sensor. Additionally, the controller 30 may estimate the weight of the implement 200 based on, for example, the rotation speeds of the plurality of sub-rotors 12 and the main rotor 22 during hovering, and the known weight of the multicopter 100. Various types of implements 200 may be connected to the coupler of the multicopter 100. Additionally, when the implement 200 performs operations such as spraying or harvesting, the weight of the implement 200 (i.e., payload) may vary as the operation progresses. By measuring the weight of the implement 200 with a sensor or estimating it based on the rotation speed of each rotor, it is possible to appropriately obtain information about the weight of the implement 200, which may vary.

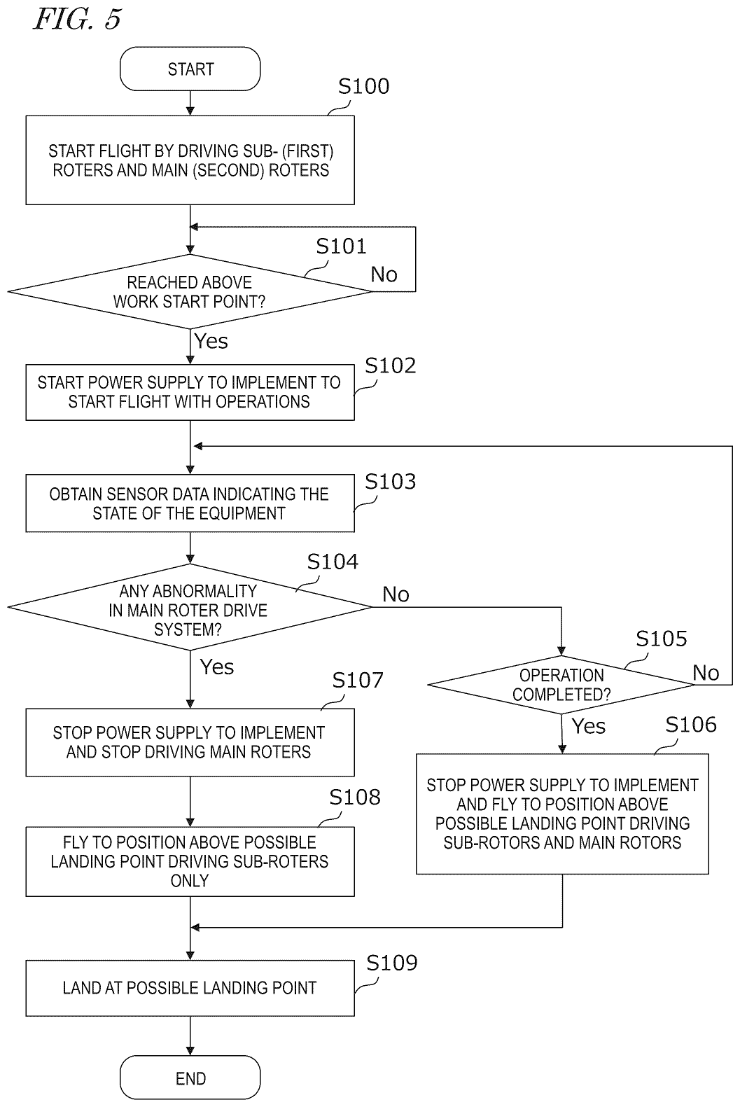

Next, referring to FIG. 5, an example of operation that transitions to emergency flight mode when an abnormality occurs in the equipment such as the drive system of the main rotor 22 during flight will be explained. FIG. 5 is a flowchart showing an example of operation by the controller 30. In this example, the multicopter 100 automatically flies along a predetermined flight path while driving the implement 200 to perform a specified agricultural work.

First, in step S100, the controller 30 starts flight of the multicopter 100 by driving each sub-rotor 12 (first rotor) and each main rotor 22 (second rotor). The controller 30 drives each sub-rotor 12 by controlling the plurality of ESCs 16 to rotate the plurality of motors 14. The controller 30 also drives each main rotor 22 by controlling the main rotor controller 26 to drive the main rotor driver 24 (internal combustion engine). The rotation speeds of each main rotor 22 and each sub-rotor 12 may be determined based on a predetermined thrust ratio between the main rotor 22 and the sub-rotor 12. The start of flight may be performed by user operation using an operation device, or according to a preset program.

In step S101, the controller 30 determines whether the multicopter 100 has reached a position above the work start point. The work start point is, for example, a point to start agricultural work in a field. The controller 30 can determine whether the multicopter 100 has reached a position above the work start point based on the position of the multicopter 100 measured by the GNSS receiver included in the sensors 72 and map data of an area including the field. When the multicopter 100 reaches a position above the work start point, the process proceeds to step S102.

In step S102, the controller 30 starts power supply to the implement 200 and starts flight with operations by the implement 200 (hereinafter may be referred to as “operation flight”). Power supply to the implement 200 may be executed by controlling the power switch 56 to electrically connect the electric generator 42 and the power supply 76.

In step S103, the controller 30 obtains sensor data indicating the state of the equipment from the sensors 72. The sensor data may include data indicating the state of the main rotor 22 drive system. The sensor data may include data indicating, for example, the output voltage or output current of the electric generator 42, rotation speed of the rotor of the electric generator 42, rotation speed of the main rotor 22, rotation speed of gears included in the power transmission system of the main rotor 22, remaining amount of fuel in the fuel tank, temperature of the fuel tank, temperature of cooling water of the internal combustion engine, and/or rotation speed or torque of the output shaft of the internal combustion engine.

In step S104, the controller 30 determines whether an abnormality in the main rotor 22 drive system has been detected based on the sensor data. When an abnormality is detected (Yes), the process proceeds to step S107. When no abnormality is detected (No), the process proceeds to step S105.

In step S105, the controller 30 determines whether the operation by the implement 200 has been completed. The controller 30 may determine that the operation has been completed when, for example, the position of the multicopter 100 measured by the GNSS receiver is above a predetermined operation end point. When the operation is completed (Yes), the process proceeds to step S106. When the operation is not completed (No), the process returns to step S103.

In step S106, the controller 30 stops power supply to the implement 200 and flies the multicopter 100 to a position above a possible landing point by driving each sub-rotor 12 and each main rotor 22. The possible landing point is, for example, a predetermined point such as a point in the field where agricultural work is not performed (for example, headland), a storage location for the multicopter 100, or a supply point where agricultural materials such as chemicals or fertilizers are supplied to the multicopter 100. When the multicopter 100 reaches a position above the possible landing point, the process proceeds to step S109.

When an abnormality in the main rotor 22 drive system is detected in step S104, the process proceeds to step S107. In step S107, the controller 30 stops the power supply to the implement 200 and the driving of the main rotor 22. Note that instead of completely stopping the power supply to the implement 200, the amount of power supplied to the implement 200 may be reduced. At this time, the controller 30 controls the power switch 56 to stop the supply of power from the electric generator 42 and the battery 52 to the power supply 76, and starts the supply of power from the battery 52 to the plurality of motors 14. Note that the controller 30 may control the power supply to the implement 200 by controlling a switch included in the power supply 76 instead of controlling the power switch 56.

In step S108, the controller 30 flies the multicopter 100 to a position above a possible landing point by driving only the sub-rotors 12. This possible landing point may be a different point from the possible landing point in step S106. In step S108, since the sub-rotors 12 are driven by power stored in the battery 52, it may not be possible to continue flying for very long. Therefore, in step S108, the controller 30 may be configured to fly the multicopter 100 to the position above a possible landing point that is relatively close to the position where the power supply to the implement 200 and driving of the main rotor 22 were stopped. When the multicopter 100 reaches a position above the possible landing point, the process proceeds to step S109.

In step S109, the controller 30 lands the multicopter 100 at the possible landing point by decreasing the rotation speed of each rotor.

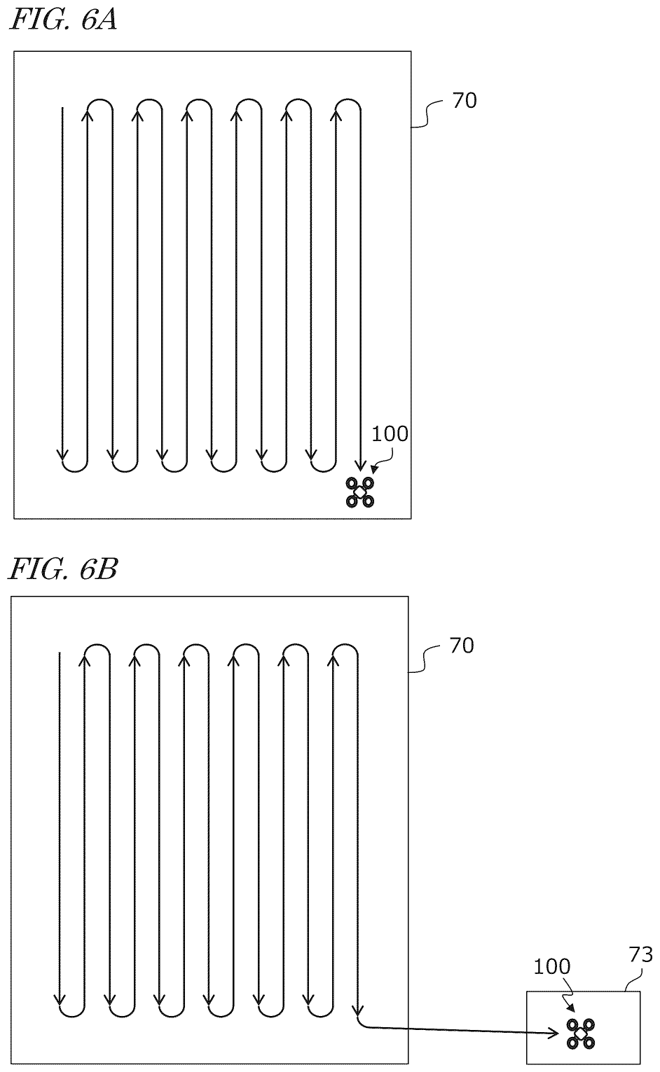

FIG. 6A is a plan view showing an example of a flight path of the multicopter 100 according to this example embodiment. In this example, the multicopter 100 flies in the field 70 while performing agricultural work such as spraying fertilizer or pesticide, or mowing grass using the implement 200. Therefore, the flight path of the multicopter 100 is regularly serpentine as indicated by arrows in the figure. The controller 30 can perform necessary ground operations on the crop area in the field 70 or on the ground itself by controlling the position, altitude, and attitude of the multicopter 100 with high precision. For such operations, the flight altitude on the flight path may be controlled to a preferable level of, for example, 0.1 m or more and 5 m or less.

In the example of FIG. 6A, no abnormality occurs in any equipment included in the multicopter 100 during agricultural work in the field 70. Therefore, after completing the agricultural work, the controller 30 stops the implement 200 and lands the multicopter 100 at a possible landing point in the outer periphery of the field 70 (for example, headland). Note that the multicopter 100 may, as shown in FIG. 6B, stop the implement 200 after completing the agricultural work, and fly to and land in area 73 outside the field 70. Area 73 is, for example, a predetermined place such as a storage location for the multicopter 100 or a supply point for agricultural materials.

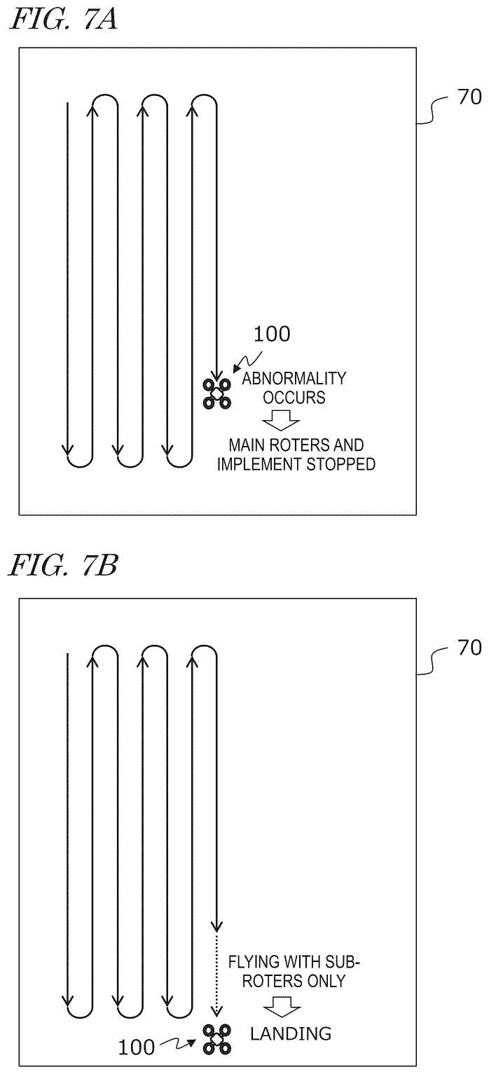

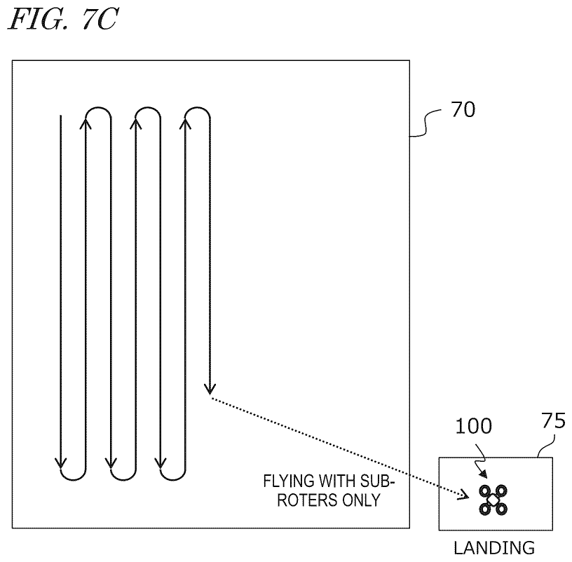

FIG. 7A is a figure showing an example of operation when an abnormality occurs in equipment included in the multicopter 100, for example, in the main rotor 22 drive system, during operation. In this example, the controller 30 has detected that an abnormality has occurred in the main rotor 22 drive system (for example, the internal combustion engine or the electric generator 42) while the multicopter 100 is performing operation flight by driving the implement 200 in the field 70. In this case, the controller 30 stops the driving of the main rotor 22 and the implement 200 and, as shown in FIG. 7B, continues flight by driving only the sub-rotors 12, and lands at a possible landing point. Note that, as mentioned earlier, instead of stopping power supply to the implement 200, it may continue ground operations to the extent possible by reducing the amount of power supply to the implement 200. In the example of FIG. 7B, the controller 30 lands the multicopter 100 at a possible landing point in the headland of the field 70 where operations are not performed. Not limited to this example, for example, as shown in FIG. 7C, the controller 30 may fly the multicopter 100 by driving only the sub-rotors 12 to a landable area 75, which is outside the field 70, and land there. Area 75 may be the same area as area 73 shown in FIG. 6B. However, when the weight of the implement 200 (i.e., payload) is large or when the power storage capacity of the battery 52 is small, the distance that can be flown by driving only the sub-rotors 12 may be short, making it difficult to fly to area 73 shown in FIG. 6B. In that case, the controller 30 lands the multicopter 100 at a possible landing point near the area where operations are performed in the field 70. Note that the position information of possible landing points is stored in advance in the storage device, and the controller 30 can move the multicopter 10 to a possible landing point based on that position information and positioning results from the GNSS receiver.

As described above, the controller 30 according to this example embodiment can, when it detects an abnormality in equipment included in the multicopter 100 during operation flight, stop or reduce the power supply to the implement 200, and continue flight by driving the plurality of sub-rotors 12 while maintaining the power supply to the plurality of electric motors 14. In particular, the controller 30 may, when it detects an abnormality in the internal combustion engine (main rotor driver 24), electric generator 42, main rotor 22, power transmission system to the main rotor 22, or fuel supply system to the internal combustion engine, stop or limit the power supply to the implement 200 and the driving of the main rotor 22, and continue flight by driving only the sub-rotors 12. With such control, since flight can be continued for a while by the sub-rotors 12 after an abnormality is detected, the multicopter 100 can be appropriately landed at a possible landing point.

In this example embodiment, the multicopter 100 automatically flies along a predetermined flight path, but the multicopter 100 may fly according to a user's operation using an operation device. Even in that case, when the controller 30 detects an equipment abnormality during operation flight, it may stop or reduce the power supply to the implement 200 and continue flight by driving the sub-rotors 12.

The multicopter 100 according to this example embodiment has a parallel hybrid drive type configuration, but it may have other configurations, for example, a battery-driven type (see FIG. 2A) or a series hybrid drive type (see FIG. 2B) configuration. The following explains an example of applying the control method of this disclosure to a battery-driven multicopter.

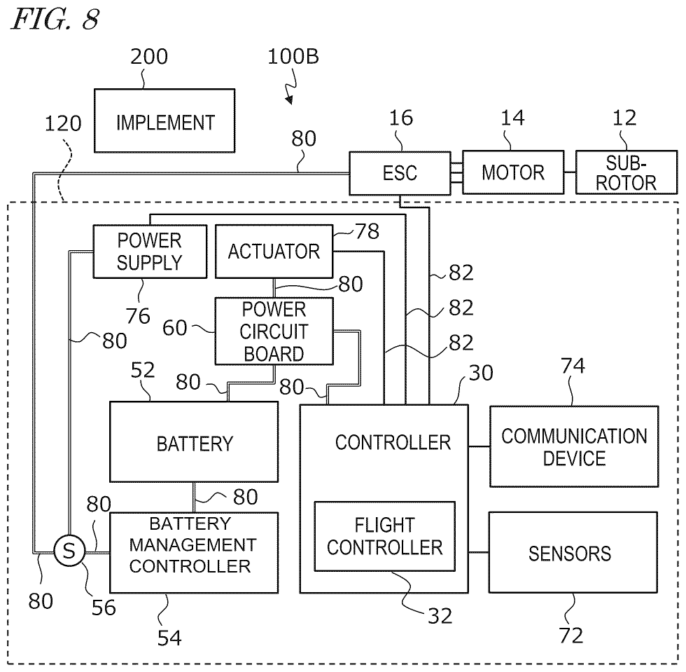

FIG. 8 is a block diagram showing an example of system configuration of a battery-driven multicopter 100B. The configuration shown in FIG. 8 corresponds to the configuration shown in FIG. 4 without the main rotor 22, main rotor driver 24, main rotor controller 26, electric generator 42, and power management controller 44. The multicopter 100B shown in FIG. 8 does not have a main rotor 22 and flies by the rotation of multiple rotors 12 driven by the battery 52.

In the example of FIG. 8, the sensors 72 may include at least one sensor that senses the operational state of each rotor 12, each motor 14, or each ESC 16. The controller 30 can detect abnormalities in any of the equipment of rotor 12, motor 14, or ESC 16 based on sensor data output from that sensor. When the controller 30 detects an abnormality in any of the equipment during operation flight, it may be configured to stop or reduce the power supply to the implement 200, stop the rotation of the rotor 12 corresponding to the equipment with the abnormality, and continue flight by rotating only the remaining rotors 12. At this time, to suppress thrust imbalance due to the stopping of the rotor 12, another rotor 12 positioned diagonally opposite to the rotor 12 corresponding to the equipment with the abnormality may also be stopped. By stopping or reducing the power supply to the implement 200, it is possible to suppress the decrease in the stored power of the battery 52, making it easier to fly to a landing point by driving the remaining sub-rotors 12.

In the above examples, operations when an abnormality in the drive system of the main rotor 22 or sub-rotor 12 is detected have been explained, but similar control may be applied when abnormalities in other equipment are detected. For example, when abnormalities occur in the communication device 74, sensors 72, or other electrical equipment, it may be required to stop operation flight and land at an appropriate place for maintenance. Therefore, when the controller 30 detects abnormalities in the communication device 74, sensors 72, or other electrical equipment based on sensor data, it may stop or limit the power supply to the implement 200, perform minimal flight by driving the sub-rotors 12 (and, if possible, the main rotors 22), and control the flight of the multicopter 100 to land at an appropriate location.

The controllers 30 according to the example embodiments of this disclosure may be implemented by digital computer systems configured or programmed to execute the various processes explained with reference to FIGS. 5 to 8.

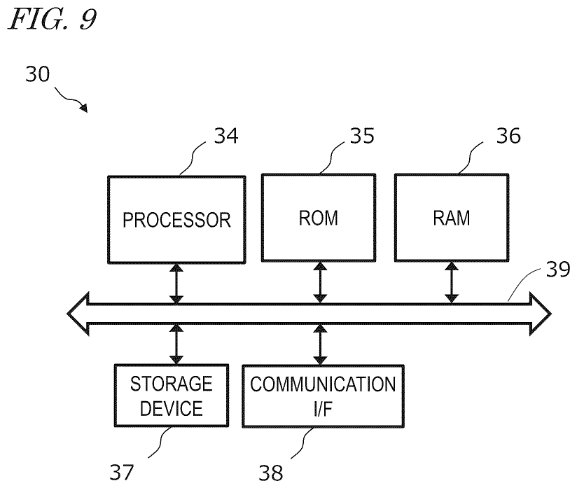

FIG. 9 is a block diagram showing an example of the hardware configuration of the controller 30. The controller 30 includes a processor 34, ROM (Read Only Memory) 35, RAM (Random Access Memory) 36, storage device 37, and communication I/F 38. These components are interconnected via a bus 39.

The processor 34 is one or more semiconductor integrated circuits, also referred to as a central processing unit (CPU) or microprocessor. The processor 34 sequentially executes computer programs stored in ROM 35 to implement the aforementioned processing. The term processor 34 is broadly interpreted to encompass devices such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of a plurality of recording media. Some of the plurality of collections may be removable memory.

The RAM 36 provides a work area for temporarily expanding programs stored in the ROM 35 during boot-up. The RAM 36 need not be a single recording medium but may be a collection of a plurality of recording media.

The communication I/F 38 is an interface for communication between the controller 30 and other electronic components or electronic controllers (ECUs). For example, the communication I/F 38 may perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data useful for autonomous flight of the multicopter 10, and various sensor data acquired by the multicopter 10 during flight.

Note that, as mentioned earlier, the controller 30 may be configured or programmed to include, as separate components, a flight controller such as the flight controller 32 and a higher-level computer (companion computer). The companion computer may execute each process shown in FIG. 5 and provide flight-related commands to the flight controller based on the results of those processes.

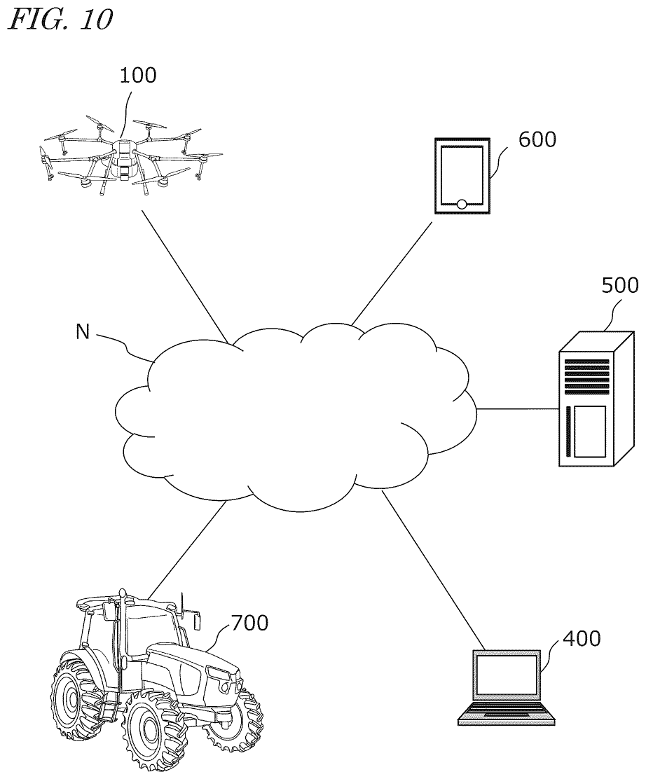

Additionally, some or all of the functions of the controller 30 may be implemented by one or more servers (computers) 500 or terminal devices (including portable and fixed types) 600 connected to the communication device 74 of the multicopter 100 via a communication network N, as shown in FIG. 10. Agricultural machines 700 such as tractors may be connected to this communication network N, and communication may be performed between the multicopter 100 and the agricultural machines 700. Through the communication network N, a portion of the data used for processing by the controller 30 and control signals for the multicopter 100 may be provided to the multicopter 100 from the agricultural machines 700.

Unmanned aerial vehicles according to example embodiments of the present disclosure may be widely utilized not only for aerial photography, surveying, logistics, and agricultural chemical spraying applications but also for ground work related to agriculture, transportation of harvested crops and agricultural materials. While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle comprising:
a plurality of rotors;
a plurality of electric motors each configured to drive a respective one of the plurality of rotors;
a power source;
a coupler configured to couple an implement that performs ground operations; and
a controller configured or programmed to control supply of first electric power from the power source to the plurality of electric motors and supply of second electric power from the power source to the implement, and control operation of the plurality of electric motors; wherein
upon detecting an abnormality in equipment included in the unmanned aerial vehicle, the controller is configured or programmed to stop the supply of the second electric power to the implement and maintain the supply of the first electric power to the plurality of electric motors to execute flight using the plurality of rotors.

2. The unmanned aerial vehicle according to claim 1, wherein upon detecting the abnormality while executing flight by controlling the plurality of electric motors while supplying the second electric power to the implement, the controller is configured or programmed to stop the supply of the second electric power to the implement and maintain the supply of the first electric power to the plurality of electric motors to continue flight using the plurality of rotors, and then land the unmanned aerial vehicle by decreasing the rotation speed of the plurality of rotors.

3. The unmanned aerial vehicle according to claim 1, wherein the plurality of rotors are a plurality of first rotors; and
the unmanned aerial vehicle further comprises:
at least one second rotor;
an internal combustion engine to drive the at least one second rotor;
an electric generator that is driven by the internal combustion engine to generate third electric power; and
a battery to store the third electric power, wherein
the power source includes the electric generator and the battery; and
the controller is configured or programmed to monitor a state of at least one of the internal combustion engine, the electric generator, the second rotor, a power transmission system to the second rotor, and a fuel supply system to the internal combustion engine, and upon detecting an abnormality in the at least one state, stop the supply of the second electric power to the implement and maintain the supply of the first electric power to the plurality of electric motors to execute flight using the plurality of first rotors while stopping the at least one second rotor.

4. The unmanned aerial vehicle according to claim 3, further comprising a battery management controller configured or programmed to control charging and discharging of the battery; wherein
while the implement is being driven by the second electric power and flight is being performed using the plurality of first rotors and the at least one second rotor, the battery management controller is configured or programmed to maintain a state of charge of the battery at a value higher than a threshold required for an operation of continuing flight using the plurality of first rotors and then landing when the abnormality is detected.

5. The unmanned aerial vehicle according to claim 4, wherein the controller is configured or programmed to obtain information indicating a weight of the implement and change a threshold for a state of charge according to the weight.

6. The unmanned aerial vehicle according to claim 1, further comprising at least one sensor to output sensor data to detect the abnormality in the equipment, wherein the controller is configured or programmed to detect the abnormality in the equipment based on the sensor data.

7. A control system for an unmanned aerial vehicle including a plurality of rotors, a plurality of electric motors each configured to drive a respective one of the plurality of rotors, a power source, and a coupler configured to couple an implement that performs ground operations, the control system comprising:
a controller configured or programmed to control supply of first electric power from the power source to the plurality of electric motors and supply of second electric power from the power source to the implement, and control operation of the plurality of electric motors; wherein
upon detecting an abnormality in equipment included in the unmanned aerial vehicle, the controller is configured or programmed to stop the supply of the second electric power to the implement and maintain the supply of the first electric power to the plurality of electric motors to execute flight using the plurality of rotors.

8. A control method for an unmanned aerial vehicle including a plurality of rotors, a plurality of electric motors each configured to drive a respective one of the plurality of rotors, a power source, and a coupler configured to couple an implement that performs ground operations, the method comprising:
controlling supply of first electric power from the power source to the plurality of electric motors and supply of second electric power from the power source to the implement;
controlling operation of the plurality of electric motors;
detecting an abnormality in equipment included in the unmanned aerial vehicle; and
upon detecting the abnormality, stopping the supply of the second electric power to the implement and maintaining the supply of the first electric power to the plurality of electric motors to execute flight using the plurality of rotors.
